(19) United States
(12) Patent Application Publication
(10) Pub. No.: US 2019/0049814 A1
(43) Pub. Date: Feb. 14, 2019

(54) METHOD AND APPARATUS FOR TWO PARTICLE TOTAL INTERNAL REFLECTION IMAGE DISPLAY

(71) Applicant: ClearINK Displays, Inc., Fremont, CA (US)

(72) Inventor: Lorne A. Whitehead, Vancouver (CA)

(73) Assignee: ClearINK Displays Inc., Fremont, CA (US)

(21) Appl. No.: 16/077,696

(22) PCT Filed: Feb. 24, 2017
(86) PCT No.: PCT/US17/19394

§ 371 Date: Aug. 13, 2018

Related U.S. Application Data
(60) Provisional application No. 62/299,498, filed on Feb. 24, 2016.

(51) Int. Cl. G02F 1/167; G02F 1/1343

(52) U.S. Cl. CPC G02F 1/167; G02F 2001/1678; G02F 1/134309

(57) ABSTRACT

Brightness in total internal reflection image displays may be enhanced by addition of a plurality of light reflecting particles. The particles may be charged, uncharged or weakly charged. The particles may be designed such that they do not enter the evanescent wave region and frustrate TIR when near the surface of the convex protrusions but be close enough to reflect light rays that pass through the dark pupil region to enhance brightness.

The disclosure claims the filing data priority of U.S. Provisional Application No. 62/299,498, filed on Feb. 24, 2016, the specification of which is incorporated herein in its entirety.

### FIELD

The disclosed embodiments are generally directed to total internal reflection-based image displays. In one embodiment, the disclosure relates to an enhanced brightness, totally internally reflective image display, comprising a plurality of light absorbing charged particles of one color and a plurality of light reflecting particles of a second color.

### BACKGROUND

Conventional total internal reflection (TIR) based displays include, among others, a transparent high refractive index front sheet in contact with a low refractive index fluid. The front sheet and fluid may have different refractive indices that may be characterized by a critical angle θ_{c}. The critical angle characterizes the interface between the surface of the transparent front sheet (with refractive index η₁) and the low refractive index fluid (with refractive index η₃). Light rays incident upon the interface at angles less than θ_{c} may be transmitted through the interface. Light rays incident upon the interface at angles greater than θ_{c} may undergo TIR at the interface. A small critical angle (e.g., less than about 50°) is preferred at the TIR interface since this affords a large range of angles over which TIR may occur. It may be prudent to have a fluid medium 120 with preferably as small a refractive index (η₃) as possible and to have a transparent front sheet composed of a material having a refractive index (η₁) preferably as large as possible. The critical angle, θ_{c}, is calculated by the following equation (Eq. 1):

$${θ}_{c} = {sin}^{- 1} ( \frac{{η}_{3}}{{η}_{1}} ) \qquad ( 1 )$$

Conventional TIR-based reflective image displays further comprise electrophoretically mobile, light absorbing particles. The electrophoretically mobile particles move in response to a bias between two opposing electrodes. When particles are moved by a voltage bias source to the surface of the front sheet they may enter the evanescent wave region and frustrate TIR. Incident light may be absorbed by the electrophoretically mobile particles to create a dark state observed by the viewer. Under such conditions, the display surface may appear dark or black to the viewer. When the particles are moved out of the evanescent wave region (e.g., by reverse biasing), light may be reflected by TIR. This creates a white or bright state that may be observed by the viewer. An array of pixelated electrodes may be used to drive the particles into and out of the evanescent wave region to form combinations of white and dark states. This may be used to create images to convey information to the viewer.

The front sheet in conventional TIR-based displays typically includes a plurality of close-packed convex structures on the inward side facing the low refractive index medium and electrophoretically mobile particles (i.e., the surface of the front sheet which faces away from the viewer). The convex structures may be hemispherically-shaped but other shapes may be used. A conventional TIR-based display 100 is illustrated in FIG. 1. Display 100 is shown with a transparent front sheet 102 further comprising a layer of a plurality of hemispherical protrusions 104, a rear support sheet 106, a transparent front electrode 108 on the surface of the hemispherical protrusions and a rear electrode 110. FIG. 1 also shows low refractive index fluid 112 which is disposed within the cavity or gap formed between the surface of protrusions 104 and the rear support sheet. The fluid 112 contains a plurality of light absorbing electrophoretically mobile particles 114. Display 100 includes a voltage source 116 capable of creating a bias across the cavity. When particles 114 are electrophoretically moved near the front electrode 108, they may frustrate TIR. This is shown to the right of dotted line 118 and is illustrated by incident light rays 120 and 122 being absorbed by the particles 114. This area of the display will appear as a dark state to viewer 124.

When particles are moved away from the front sheet 102 towards the rear electrode 110, as shown to the left of dotted line 118, incident light rays may be totally internally reflected at the interface of the surface of electrode 108 on hemispherical array 104 and medium 112. This is represented by incident light ray 126, which is totally internally reflected and exits the display towards viewer 124 as reflected light ray 128. The display appears white or bright to the viewer.

In some instances, light rays may not be totally internally reflected and may instead pass through front sheet 102 and then be lost or internally absorbed. Such conditions decrease the overall brightness of the display. Light ray 130 in FIG. 1 represents a light ray that is incident on the interface at less than the critical angle. Light ray 130 passes through the so called dark pupil region and is not reflected.

### BRIEF DESCRIPTION OF DRAWINGS

These and other embodiments of the disclosure will be discussed with reference to the following exemplary and non-limiting illustrations, in which like elements are numbered similarly, and where:

FIG. 1 schematically illustrates a cross-section of a portion of a conventional TIR-based display;

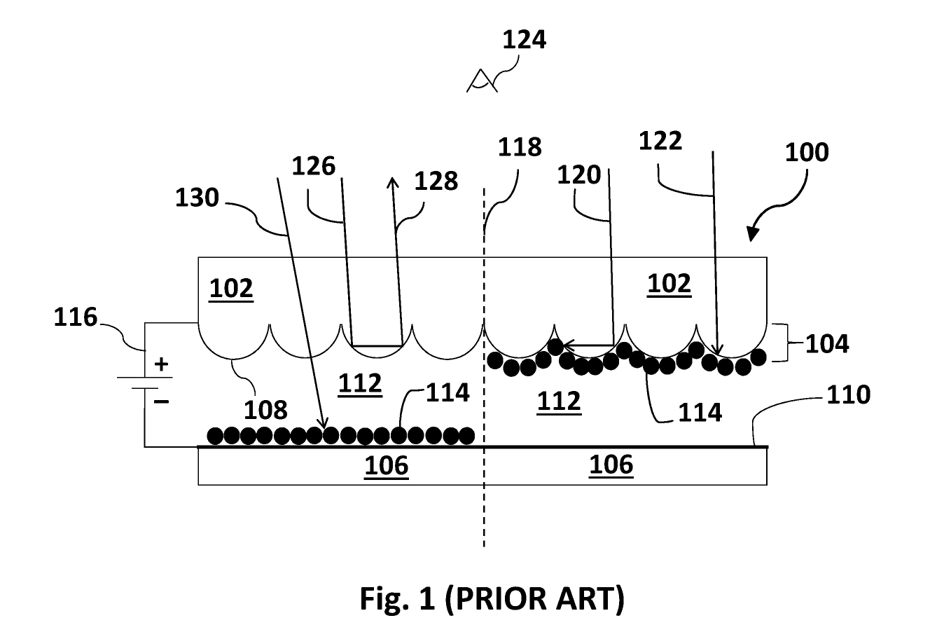

FIG. 2 schematically illustrates a cross-section of a portion of a front sheet of a TIR-based display according to one embodiment of the disclosure;

FIG. 3 schematically illustrates a cross-section of a portion of a front sheet of a TIR-based display according to another embodiment of the disclosure; and

FIG. 4 schematically illustrates an exemplary system for implementing an embodiment of the disclosure.

### DETAILED DESCRIPTION

Throughout the following description specific details are set forth in order to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive sense.

This disclosure generally relates to a two-particle TIR image display. Pluralities of particles of opposite charge polarity with substantially similar electrophoretic mobility and different optical characteristics may be employed to frustrate TIR and to create a dark state or a brightness-enhanced white state. In certain embodiments, two pluralities of particles may be employed where a first plurality of particles are charged with a first type of polarity while a second plurality of particles are uncharged or weakly charged of an opposite charge polarity. One of the pluralities of particles may be light reflective. As light rays pass through the front sheet at angles less than the critical angle, the light reflective particles may substantially reflect the light back towards viewer 124 leading to a brighter display.

In certain embodiments, the disclosure provides a TIR image display with a first plurality of electrophoretically mobile light reflecting particles and a second plurality of electrophoretically mobile light absorbing particles. The display may provide brightness enhancement as compared to conventional displays. In one embodiment, electrophoretically mobile light absorbing particles comprising a first charge polarity are combined with oppositely charged, weakly charged or non-charged light reflective particles to enhance brightness of the display when a bias is applied to the respective electrodes.

In certain embodiments, the electrophoretically mobile particles (herein, particles) may include a core portion and a coating portion.

In certain embodiments, light reflective particles may have a coating and charge polarity. When such particles are moved proximal to the front electrode, the light absorbing particles which may have an opposite charge are moved to the rear electrode by applying a non-zero voltage bias. The core of the light reflective particles may be physically unable to move close enough to the front electrode to frustrate TIR. But such particles may get close enough to the front electrode to reflect light back towards the viewer that passes through the dark pupil regions of the protrusions. This may enhance the brightness of the display.

In another exemplary implementation, light reflective particles may comprise a coating that is weakly charged or is substantially without charged. The light reflective particles may be dispersed in the low refractive fluidic index medium. The coating on the light reflective particles may have a refractive index similar to the refractive index of the medium. The light reflecting particles may not be moved or may only minimally move in the presence of a non-zero voltage bias. The light absorbing electrophoretically mobile particles with a charge polarity may be moved to the rear electrode by application of a non-zero voltage bias. The dispersed light reflecting particles may not frustrate TIR but may reflect light back towards the viewer that passes through the dark pupil regions of the protrusions.

It should be noted that while the exemplary embodiments are discussed in relation with a display having two types of particles with different optical characteristics, the disclosed principles are not limited thereto. The disclosed principles are applicable to multiple types of particles with varying degree of optical and/or electromagnetic characteristics.

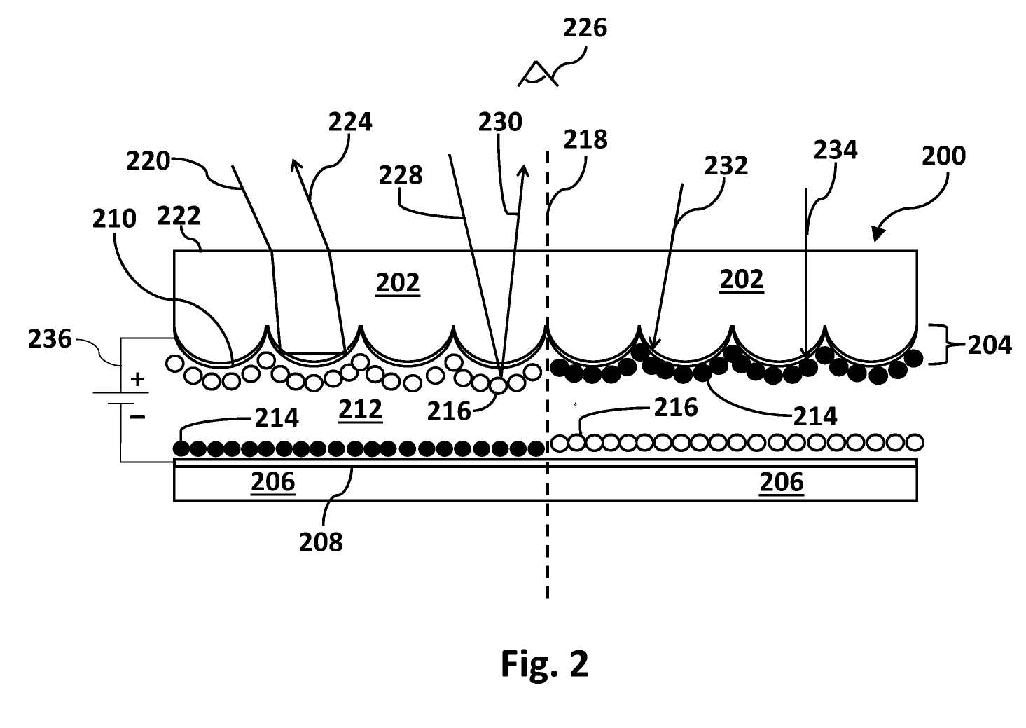

FIG. 2 schematically illustrates a cross-section of a portion of a front sheet of a TIR-based display according to one embodiment of the disclosure. Display embodiment 200 in FIG. 2 shows transparent front sheet 202 further having a layer of a plurality of high refractive index convex protrusions 204 on the inward surface. In certain embodiments, the high refractive index protrusions may include materials having a refractive index in the range of about 1.5 to 2.2. In certain other embodiments, the high refractive index protrusions may be a material having a refractive index of about 1.6 to about 1.9. In some embodiments, front sheet 202 and protrusions 204 may be a continuous sheet of substantially the same material. In other embodiments, front sheet 202 and protrusions 204 may be formed of different materials having similar or different refractive indices. In an exemplary embodiment, front sheet 202 may comprise glass. Front sheet 202 may comprise a polymer such as polycarbonate. In an exemplary embodiment, protrusions 204 may comprise a high refractive index polymer. The refractive index of protrusions 204 may be greater than about 1.5. In some embodiments, the convex protrusions 204 may be in the shape of hemispheres as illustrated in FIG. 2. Protrusions 204 may be of any shape or size or a mixture of shapes and sizes. Protrusions 204 may be elongated hemispheres or hexagonally shaped or a combination thereof. In other embodiments, the convex protrusions may be microbeads embedded in front sheet 202. In some embodiments, the convex protrusions may be randomly sized and shaped. In some embodiments, the front sheet and layer of convex protrusions may be a continuous layer. In an exemplary embodiment, front sheet 202 and layer of convex protrusions 204 may define separate layers.

Embodiment 200 comprises rear support layer 206. Rear support 206 may include a rear electrode layer 208. Rear electrode layer 208 may be one or more of a thin film transistor layer, passive matrix array of electrodes or a patterned electrode array. Rear electrode 208 may be integrated with rear support layer 206. Alternatively, rear electrode 208 may be positioned proximal to rear support 206. In still another embodiment, rear electrode 208 may be laminated or attached to rear support 206.

Front sheet 202 may further comprise a front electrode layer 210 on the surface supporting convex protrusions 204. Front electrode 210 may comprise a transparent conductive material such as indium tin oxide (ITO), Baytron™, or conductive nanoparticles, metal nanowires, graphene or other conductive carbon allotropes or a combination of these or similar material(s) dispersed in a substantially transparent polymer.

As illustrated in FIG. 2, a gap or cavity is formed between front electrode 210 and rear electrode 208. Contained within the cavity, may be an air or fluid medium 212. Medium 212 may be an inert, low refractive index fluid medium with a refractive index of less than about 1.5. In other embodiments, the refractive index of medium 212 may be about 1 to 1.5. In still other embodiments the refractive index of medium 212 may be about 1.1 to 1.4. Medium 212 may be a hydrocarbon. In an exemplary embodiment, medium 212 may be a fluorinated hydrocarbon. In another exemplary embodiment, medium 212 may be a perfluorinated hydrocarbon. In an exemplary embodiment, medium 212 has a lower refractive index than convex protrusions 204. Medium 212 may further comprise a viscosity modifier. Conventional viscosity modifiers include oligomers or polymers. Viscosity modifiers may include one or more of a styrene, acrylate, methacrylate or other olefin-based polymers. In one embodiment, the viscosity modifier is polyisobutylene or a halogenated polyisobutylene.

Medium 212 may further include a first plurality of light absorbing electrophoretically mobile particles 214. Mobile particles 214 may comprise a first charge polarity and first optical characteristic (i.e. color or light absorption characteristic). Medium 212 may further include a second plurality of electrophoretically mobile particles 216. Mobile particles 216 may comprise a second charge of opposite polarity and a second optical characteristic. Particles 214 or 216 may have broadband (i.e., substantially all optical wavelengths) light reflection characteristics. Particles 214 or 216 may also have any light absorption characteristics such that they may impart any color of the visible spectrum or a combination of colors to give a specific shade or hue. In one embodiment, particles 214 and 216 have substantially the same or different colors. In some embodiments, there may be a higher weight % of light absorbing particles 214 than light reflecting particles 216 in medium 212. In some embodiments, the light reflecting particles 216 may comprise about 0.5 to 40 weight % of the total composition of the medium 212, light absorbing particles and light reflecting particles 216. In other embodiments, the light reflecting particles 216 may comprise about 0.5 to 30 weight % of the total composition of the medium 212, light absorbing particles 214 and light reflecting particles 216. In still other embodiments the light reflecting particles 216 may comprise about 0.5 to 20 weight % of the total composition of the medium 212, light absorbing particles 214 and light reflecting particles 216. In other embodiments, there may be a higher weight % of light reflecting particles 216 than light absorbing particles 214 in medium 212. In still other embodiments, the weight % of light reflecting particles 216 and the weight % of light absorbing particles 214 may be about the same.

In certain embodiments, particles 214, 216 may be formed of an organic material or an inorganic material or a combination of an organic and inorganic material. Particles 214, 216 may be a dye or a pigment or a combination thereof. Particles 214, 216 may be at least one of carbon black, a metal or metal oxide or a combination thereof. Particles 214, 216 may have a polymer coating. In one embodiment, particles 214 and 216 may be oppositely charged. In another embodiment, particles 214 and 216 may be similarly charged but have varying degree of charge such that, for example, particles 214 have a higher charge polarity than particles 216. In still another embodiment, one of particles 214 or particles 216 may not have a charge polarity while the other does.

In an exemplary embodiment, one of the pluralities of particles defines a substantially light reflective particle while the other defines a light absorbing particle. For illustrative purposes, particles 216 in FIG. 2 may comprise a white reflective particle such as titanium dioxide (TiO₂).

In an exemplary embodiment, particles 216 may be about 200-300 nm in diameter. This and similar sizes have been found to maximize light reflectance properties of the electrophretically mobile particles. Particles of larger or smaller sizes may also be used without departing from the disclosed principles.

Particles 216 may further comprise a core and a coating (not shown). The coating may comprise an effective refractive index that is substantially similar to the refractive index of medium 212. By having a refractive index similar to the medium, the coating may come into contact with the front electrode but may not frustrate TIR. In other instances, the coating of the particles may not come into contact with the front electrode but instead may only enter the evanescent wave region near the front electrode. By having a refractive index substantially similar to the medium, the coating may not frustrate TIR even if it is in the evanescent wave region. Thus, the coating creates a steric hindrance condition whereby the core of the particle remains at a distance away from the electrode. In some embodiments, the steric hindrance prevents the core from coming into contact with the front electrode. This condition may be used alone or in combination with relative differences between the refractive index values of the medium and the coating of the light-refracting particles (as discussed below) to obtain additional synergistic TIR performance.

In an exemplary embodiment, the difference between the refractive indices of the coating on the light reflecting particles and medium 212 may be less than about 30%. In other embodiments, the difference between the refractive indices of the coating on the light reflecting particles and medium 212 may be within about 1-20%. In still other embodiments, the difference between the refractive indices of the coating on the light reflecting particles and medium 212 may be within about 5-15%.

The coating layer of particles 216 may provide a steric hindrance layer to thereby prevent the core of the particles from coming into contact with front electrode 210 or rear electrode 208 but not may frustrate TIR. The coating may be an inorganic material and include one or more of silica (SiO₂), alumina (Al₂O₃) or other material. The coating may be a uniform layer or may be a porous or non-porous material. The coating may also define a smooth, acicular or spike-like structure. The coating may be an organic material such as a polymer. The polymer may be in the form of a brush or may comprise chain lengths of varying size, length and degree of branching. The polymers may be block copolymers. The polymers may be anchored to the particles using linker molecules. The coating may comprise a combination of inorganic and organic layers.

In certain embodiments, regardless of the composition, design or morphology of the coating on particles 216, the overall effective refractive index of the coating layer (where the effective refractive index is the refractive index of the coating material if the coating is uniform, and the effective refractive index is a value intermediate between the coating material index and the surrounding medium index if the coating is formed by a porous, needle-like or spike-like structure) may be less than about 30%. In other embodiments, the difference between the effective refractive index of the coating on the light reflecting particles 216 and the refractive index of medium 212 may be within about 20% (i.e., 0-20%). In some embodiments, the difference between the effective refractive index of the coating on the light reflecting particles 216 and the refractive index of medium 212 may be within about 10-20%. In still other embodiments, the difference between the effective refractive index of the coating on the light reflecting particles 216 and the refractive index of medium 212 may be within about 0-10%.

The coating on the light reflective particles 216 may also aid in the dispersability of the particles in medium 212 and prevent or mitigate particle settling and migration. For example, the coating may impart additional surfactant-like qualities to the particles.

Display embodiment 200 may include a voltage bias source 236. The bias source may create an electromagnetic flux in the gap formed between front electrode 210 and rear electrode 208. The flux may extend to any medium 212 disposed in the gap. The flux may move at least one of particles 214, 216 towards one electrode and away from the opposing electrode.

The voltage source 236 may be coupled to one or more processor circuitry and memory circuitry configured to change or switch the applied bias in a predefined manner and/or for predetermined durations. For example, the processing circuitry may switch the applied bias to display characters on display 200.

Display 200 may further include an optional dielectric layer (not shown) positioned on the surface of transparent front electrode 210 and interposed between transparent front electrode 210 and medium 212. Display 200 may further include an optional dielectric layer (not shown) positioned on the surface of the rear electrode 208 and interposed between the rear electrode 208 and medium 212. The one or more dielectric layers may be used to protect one or both of the front electrode layer 210 and/or rear electrode layer 208. In some embodiments, the dielectric layer on the front electrode may comprise a different composition than the dielectric layer on the rear electrode.

The dielectric layers may be substantially uniform, continuous and substantially free of surface defects. The dielectric layer may be at least about 5 nm in thickness or more. In some embodiments, the dielectric layer thickness may be about 5 to 300 nm. In other embodiments, the dielectric layer thickness may be about 5 to 200 nm. In still other embodiments, the dielectric layer thickness may be about 5 to 100 nm. The dielectric layers may each have a thickness of at least about 80 nanometers. In an exemplary embodiment, the thickness may be about 80-200 nanometers. In other embodiments, parylene may have a thickness of about 20 nanometers. The dielectric layers may comprise at least one pin hole. The dielectric layer may define a conformal coating and may be free of pin holes or may have minimal pin holes. The dielectric layer may also be a structured layer. Dielectric compounds may be organic or inorganic in type. The most common inorganic dielectric material is SiO₂ commonly used in integrated chips. The dielectric layer may be SiN. Organic dielectric materials are typically polymers such as polyimides, fluoropolymers, polynorbornenes and hydrocarbon-based polymers lacking polar groups. The dielectric layer may be a polymer or a combination of polymers. In an exemplary embodiment, the dielectric layers comprise parylene. In other embodiments the dielectric layers may comprise a halogenated parylene. Other inorganic or organic dielectric materials or combinations thereof may also be used for the dielectric layers.

In certain embodiments, display 200 may be operated as follows. For illustrative purposes, it may be assumed that particles 214 comprise a positive charge polarity and particles 216 comprise a negative charge polarity for illustrative purposes only. On the left side of dotted line 218, a negative voltage bias may be applied at rear electrode 208 to attract the positively charged light absorbing particles 214 to the rear electrode 208. A positive bias (relative to the electrical potential of the rear electrode) may be applied at the front electrode layer 210 to attract the negatively charged light reflective or scattering particles 216 to near the front electrode layer 210. Particles 216 may comprise a coating. The coating may prevent the core of particles 216 from coming into contact with the front electrode layer 210 due to steric hindrance imparted by the coating.

Depending on the coating composition of particles 216, the particles may not be able to substantially enter the evanescent wave region near the surface of the front electrode 210 or near the optional dielectric layer placed on the front electrode. As a result, total internal reflection of incident light may not be frustrated by particles 216 and is allowed to occur at the interface with the medium 212. This condition is schematically illustrated by incident light ray 220 that may enter the display through outer surface 222 of sheet 202. Light ray 220 may be totally internally reflected as light ray 224 back towards viewer 226 viewing the display. In an exemplary embodiment, the overall effective refractive index of the coating of particles 216 is substantially similar to the refractive index of medium 212. By having the refractive index of the coating substantially similar to medium 212, this may prevent frustration of TIR when particles 216 are near the front electrode.

Particles 216 near the front electrode and therefore occluding from view absorptive particles 214 also increases the reflectance of the display. This is due to the light reflecting particles 216 hiding the light absorbing particles 214 which prevents light that passes through and being absorbed by the light absorbing particles. TIR-based displays suffer from the so-called dark pupil effect. In general, not all light rays undergo TIR. For example, in the case of hemispherical optical structures, light that is incident on the center of the convex protrusions (the location also depends on the viewing angle of the display) may pass through the protrusions and not be reflected back towards the viewer. Thus, these regions can be considered as the dark pupil region. This lowers the brightness of the display. By having a layer of light-reflecting or light-scattering particles (such as particles 216 on the left side of the dotted line 218 in FIG. 2) near the surface, light that may typically pass through the dark pupil region and be lost may instead be reflected back towards viewer 226. This may increase the overall brightness of the display to create a brighter light or white state. In FIG. 2, this is represented by incident light ray 228 which is reflected or scattered by particles 216 back towards viewer 226 as reflected light ray 230.

Display 200 of FIG. 2 may also be capable of forming a dark state as shown on the right side of dotted line 218. Applying a negative voltage bias at the front electrode 210 attracts the positively charged light absorbing particles 214 towards front electrode layer 210 and into the evanescent wave region while the negatively charged light reflective particles 216 may move to the rear electrode layer 208. In this location at the front electrode, particles 214 may absorb light and frustrate TIR to create a dark state of the display. This is represented by incident light rays 232, 234 that pass through transparent front sheet 202 and are absorbed by light absorbing particles 214.

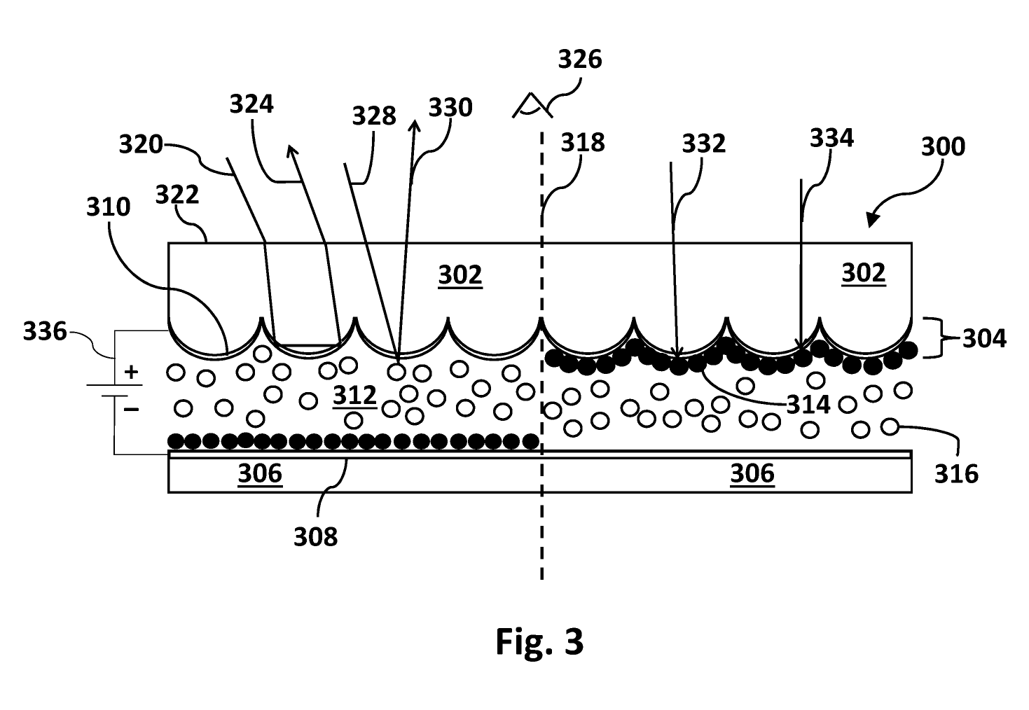

FIG. 3 schematically illustrates a cross-section of a portion of a front sheet of a TIR-based display according to another embodiment of the disclosure. Display 300 comprises a transparent front sheet 302 having a layer of a plurality of convex protrusions 304 on its inward surface, a rear support 306, rear electrode 308 and transparent front electrode 310. Display 300 may further include medium 312 having a first plurality of particles 314 and second plurality of particles 316. Display 300 may include a voltage source 336 and at least one dielectric layer (not shown).

In FIG. 3, electrophoretically mobile particles 314 may comprise a first charge polarity and first optical characteristic (i.e. color or light absorption characteristic). Whereas in the embodiment of FIG. 2 all light reflecting particles are charged, particles 316 of FIG. 3 may comprise a second optical characteristic but do not comprise a charge polarity or only a very weak (i.e., very low charge density) charge polarity. Particles 314 or 316 may have broadband (i.e. all wavelengths) light reflection characteristics or may have any light absorption characteristics such that they impart any color of the visible spectrum or a combination of colors to give a specific shade or hue. Particles 314, 316 may be formed of an organic material or an inorganic material or a combination of an organic and inorganic material. Particles 314, 316 may be a dye or a pigment or a combination thereof. Particles 314, 316 may be at least one of carbon black, a metal or metal oxide. The particles may have a polymer coating. In one embodiment, particles 314 may comprise a positive charge polarity. In other embodiments particles 314 may comprise a negative charge polarity. In certain embodiments, the particles may have a combination of positive and negative charge polarity.

In an exemplary embodiment, one of the pluralities of particles 314, 316 comprises at least one light reflective or light scattering particle while the other plurality of particles may be light absorbing. For illustrative purposes, particles 316 in FIG. 3 comprise light reflective particles such as titanium dioxide (TiO₂). In an exemplary embodiment, particles 316 may comprise at least one dimension of around 200-300 nm in length. Particles of larger or smaller sizes may also be used.

Particles 316 may further comprise a coating (not shown) substantially covering a core. The coating may comprise of an effective refractive index that is substantially similar to the refractive index of medium 312. By having a refractive index similar to the medium, the coating may come into contact with the front electrode but may not frustrate TIR. In other instances, the coating of the particles may not come into contact with the front electrode but instead may only enter the evanescent wave region near the front electrode. By having a refractive index similar to the medium, the coating may not frustrate TIR even if it is in the evanescent wave region. In an exemplary embodiment, the difference between the refractive indices of the coating on light reflecting particles 316 and medium 312 may be about 0.2 or less. The coating on particles 316 may comprise of a steric hindrance layer to prevent the core of the particles from coming into contact with front electrode 310 (and frustrate TIR) or rear electrode 308 layers. In certain embodiments, regardless of the composition, design or morphology of the coating on particles 316, the overall effective refractive index of the coating layer (where the effective refractive index is the refractive index of the coating material if the coating is uniform, and the effective refractive index is a value intermediate between the coating material index and the surrounding medium index if the coating is formed by a porous, needle-like or spike-like structure) may be less than about 30%. In other embodiments, the difference between the effective refractive index of the coating on the light reflecting particles 316 and the refractive index of medium 312 may be within about 0.1-20%. In still other embodiments, the difference between the effective refractive index of the coating on the light reflecting particles 316 and the refractive index of medium 312 may be within about 0.1-10%.

The coating on the light reflective particles 316 may also aid in the dispersability of the particles in medium 312 and prevent or mitigate particle settling and migration. For example, the coating may impart additional surfactant-like qualities to the particles.

In some embodiments, there may be a higher weight % of light absorbing particles 314 than light reflecting particles 316 in medium 312. In some embodiments, the light reflecting particles 316 may comprise about 0.5 to 40 weight % of the total composition of the medium 312, light absorbing particles 314 and light reflecting particles 316. In other embodiments, the light reflecting particles 316 may comprise about 0.5 to 30 weight % of the total composition of the medium 312, light absorbing particles 314 and light reflecting particles 316. In still other embodiments the light reflecting particles 316 may comprise about 0.5 to 20 weight % of the total composition of the medium 312, light absorbing particles 314 and light reflecting particles 316. In other embodiments, there may be a higher weight % of light reflecting particles 316 than light absorbing particles 314 in medium 312. In still other embodiments, the weight % of light reflecting particles 316 and the weight % of light absorbing particles 314 may be about the same.

The coating of particles 316 may be an inorganic material such as silica (SiO₂) or alumina (Al₂O₃) or other material or a combination thereof. The coating may be a uniform layer or may comprise a porous or needle-like or spike-like structure. The coating may be an organic material such as a polymer. The polymer may be in the form of a brush or may comprise chain lengths of varying size, length and degree of branching. The polymer may be a block copolymer. The coating may comprise a combination of inorganic and organic layers. The coating on particles 316 may also help the particles to remain suspended in medium 312 and to prevent agglomeration.

A viscosity modifier may also be added to medium 312 to limit particle migration and settling.

Display embodiment 300 in FIG. 3 may be operated as follows. It is assumed that particles 314 comprise a positive charge polarity and particles 316 do not comprise a charge polarity for illustrative purposes only. In other embodiments particles 314 may comprise a negative charge polarity.

On the left side of dotted line 318, a negative voltage bias (relative to the electrical potential of the front electrode) may be applied at the rear electrode 308 to attract the positively charged light absorbing particles 314 to the rear electrode 308. The uncharged light reflective or scattering particles 316 may not substantially move to either electrode layer and remain substantially dispersed in medium 312. In an exemplary embodiment, particles 316 may comprise a coating. The coating may prevent the core of particles 316 from coming into contact or only minimal contact with the front electrode layer 310 due to steric hindrance imparted by the coating. Depending on the composition of the coating on the particles 316, the particles may not be able to enter the evanescent wave region near the surface of the front electrode 310. As a result, total internal reflection of incident light may not be frustrated by particles 316 at the interface with medium 312. This is represented by incident light ray 320. Light ray 320 passes through outer surface 322 of sheet 302 and may be totally internally reflected as light ray 324 back towards viewer 326 viewing the display. In an exemplary embodiment, the overall effective refractive index of the coating of the particles is similar to the refractive index of medium 312. This may also aid in preventing the frustration of TIR. Particles 316 near the front electrode may also increase the reflectance of the display by occluding from view light absorptive particles 314.

Not all light rays may undergo TIR. In the case of hemispherical shaped optical convex structures, light that is incident on the center of the convex protrusions (the location also depends on the viewing angle of the display) may pass through the protrusions in the dark pupil region and not be reflected back towards the viewer. This may lower the overall brightness of the display. By having a layer of light reflecting or scattering particles (such as particles 316 on the left side of the dotted line 318 in FIG. 3) near the surface, light that may typically pass through the dark pupil region and be lost may instead be reflected back towards viewer 326. This may increase the overall brightness of the display to create a brighter light or white state. This is represented by incident light ray 328 that may be reflected or scattered by particles 316 back towards viewer 326 as reflected light ray 330.

Display embodiment 300 in FIG. 3 may also be capable of forming a dark state as shown on the right side of dotted line 318. Applying a negative voltage bias at the front electrode 310 may attract the positively charged light absorbing particles 314 towards front electrode layer 310 and into the evanescent wave region while the uncharged or weakly charged particles 316 remain dispersed in medium 312. In this location at the front electrode, particles 314 may absorb light or frustrate TIR to create a dark state of the display. This is represented by incident light rays 332, 334 that pass through transparent front sheet 302 and may be absorbed by light absorbing particles 314.

In other embodiments, front electrodes 210 and 310 in display embodiments 200 and 300, respectively, may further comprise a porous, low effective refractive index coating. The pores may allow for lower refractive index medium 212, 312 and particles 214, 314 to enter to frustrate TIR to create a dark state of the display. Light reflecting or scattering particles 216, 316 may not be allowed to enter due to their coating but may be capable of reflecting light that has passed through the dark pupil regions of the convex protrusions and porous layer and back towards the viewer. This may enhance the bright state of the display.

In other embodiments, any of the display embodiments described herein may comprise a plurality of light reflecting particles and a plurality of light absorbing particles of the same charge polarity.

In other embodiments, any of the reflective image display embodiments disclosed herein may further include at least one spacer structure. The spacer structures may be used to control the gap between the front and rear electrodes. Spacer structures may be used to support the various layers in the displays. The spacer structures may be in the shape of circular or oval beads, blocks, cylinders or other geometrical shapes or combinations thereof. The spacer structures may comprise glass, metal, plastic or other resin or a combination thereof.

In other embodiments, a color filter layer may be employed with the disclosed display embodiments. The color filter layer may be located over the outward surface of the transparent front sheet facing the viewer. In an exemplary embodiment, the color filter layer may be located between the outer transparent layer and the plurality of convex protrusions. In another exemplary embodiment, the plurality of convex protrusions may be formed directly on the color filter layer. The color filter layer may include, among others, red, green and blue filters or cyan, magenta and yellow filters.

At least one edge seal may be employed with the disclosed display embodiments. The edge seal may prevent ingress of moisture or other environmental contaminants from entering the display. The edge seal may be a thermally, chemically or a radiation cured material or a combination thereof. The edge seal may comprise one or more of an epoxy, silicone, polyisobutylene, acrylate or other polymer based material. In some embodiments the edge seal may comprise a metallized foil. In some embodiments the edge sealant may comprise a filler, such as SiO₂ or Al₂O₃.

At least one sidewall (may also be referred to as cross-walls or partition walls) may be employed with the disclosed display embodiments. The sidewalls may limit particle settling, drift and diffusion to improve display performance and bistability. The sidewalls may be located within the light modulation layer comprising the particles and medium. The sidewalls may completely or partially extend from the front electrode, rear electrode or both the front and rear electrodes. The sidewalls may comprise plastic, metal or glass or a combination thereof. The sidewalls may be any size or shape. The sidewalls may have a rounded cross-section. The sidewalls may have a refractive index about the same as the refractive index of the convex protrusions. In an exemplary embodiment the sidewalls may be optically active. The sidewalls may create wells or compartments (not shown) to confine the electrophoretically mobile particles. The sidewalls or cross-walls may be configured to create wells or compartments in, for example, square-like, triangular, pentagonal or hexagonal shapes or a combination thereof. The side walls may comprise a polymeric material and patterned by one or more conventional techniques including photolithography, embossing or molding. The sidewalls may help confine the mobile particles to prevent settling and migration of said particles that may lead to poor display performance over time. In certain embodiments, the displays may include sidewalls that completely bridge the gap created by the front and rear electrodes in the region where the air or liquid medium and the electrophoretically mobile particles reside. In certain other embodiments, the reflective image display described herein may comprise partial sidewalls that only partially bridge the gap created by the front and rear electrodes in the region where the air or liquid medium and the mobile particles reside. In certain embodiments, the reflective image display may further include a combination of sidewalls and partial sidewalls that may completely and partially bridge the gap created by the front and rear electrodes in the region where the medium and the electrophoretically mobile particles reside.

A directional front light may be employed with the disclosed display embodiments. The directional front light system may include a light source, light guide and an array of light extractor elements on the outward surface of the front sheet in each display. The directional light system may be positioned between the outward surface of the front sheet and the viewer. The front light source may define a light emitting diode (LED), cold cathode fluorescent lamp (CCFL) or a surface mount technology (SMT) incandescent lamp. The light guide may be configured to direct light to the front entire surface of the transparent outer sheet while the light extractor elements direct the light in a perpendicular direction within a narrow angle, for example, centered about a 30° cone, towards the front sheet. A directional front light system may be used in combination with cross-walls or a color filter layer in the display architectures described herein or a combination thereof. In some embodiment, the directional front light system may be flexible.

In some embodiments, a light diffusive layer may be employed with the disclosed display embodiments. In other embodiments, a light diffusive layer may be used in combination with a front light. In some embodiments, the light diffusive layer may be positioned over front sheet 202 or 302 facing viewer 226 or 326. In other embodiments, the light diffusive layer may be interposed between the front sheet 202, 302 and layer of convex protrusions 204, 304.

In some embodiments, a porous reflective layer may be used in combination with the disclosed display embodiments. The porous reflective layer may be interposed between the front and rear electrode layers. In other embodiments, the rear electrode may be located on the surface of the porous electrode layer.

In other embodiments, the reflective image displays comprising a first and a second plurality of particles described herein may further include at least one or more of charge control agents or viscosity modifiers. In still another embodiment, more than two pluralities of particles may be included in the system.

In other embodiments, any of the reflective image displays comprising two pluralities of particles described herein may further include a light diffusive layer to “soften” the reflected light observed by the viewer. In other embodiments, a light diffusive layer may be used in combination with a front light.

Various control mechanisms for the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

In some embodiments, a tangible machine-readable non-transitory storage medium that contains instructions may be used in combination with the disclosed display embodiments. In other embodiments, the tangible machine-readable non-transitory storage medium may be further used in combination with one or more processors.

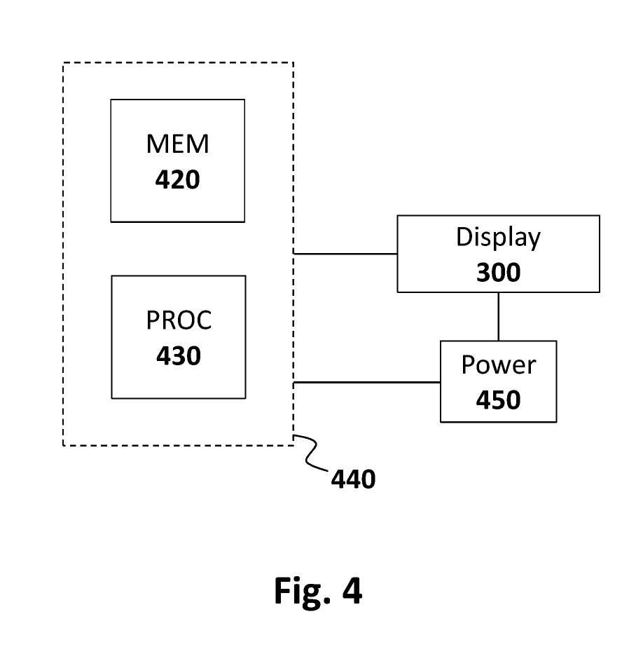

FIG. 4 shows an exemplary system for controlling a display according to one embodiment of the disclosure. In FIG. 4, display 300 is controlled by controller 440 having processor 430 and memory 420. Other control mechanisms and/or devices may be included in controller 440 without departing from the disclosed principles. Controller 440 may define hardware, software or a combination of hardware and software. For example, controller 440 may define a processor programmed with instructions (e.g., firmware). Processor 430 may be an actual processor or a virtual processor. Similarly, memory 420 may be an actual memory (i.e., hardware) or virtual memory (i.e., software).

Memory 420 may store instructions to be executed by processor 430 for driving a display (e.g., display 200 or 300). The instructions may be configured to operate the display by effectively switching or changing the applied bias to one or more of the front and rear electrodes. In one embodiment, the instructions may include biasing electrodes through power supply 450. When biased, the electrodes may cause movement of electrophoretic particles towards or away from a region proximal to the surface of the plurality of protrusions at the inward surface of the front transparent sheet to thereby absorb or reflect light received at the inward surface of the front transparent sheet. By appropriately biasing the electrodes, particles (e.g., particles 214 in FIG. 2; particles 314 in FIG. 3) may be moved near the surface of the plurality of protrusions at the inward surface of the front transparent sheet into or near the evanescent wave region in order to substantially or selectively absorb or reflect the incoming light. Absorbing the incoming light creates a dark or colored state. By appropriately biasing the electrodes, particles (e.g., particles 214 in FIG. 2; particles 314 in FIG. 3) may be moved away from the surface of the plurality of protrusions at the inward surface of the front transparent sheet and out of the evanescent wave region in order to reflect or absorb the incoming light. Reflecting the incoming light creates a light state.

The exemplary displays disclosed herein may be used as electronic book readers, portable computers, tablet computers, cellular telephones, smart cards, signs, watches, wearables, shelf labels, flash drives and outdoor billboards or outdoor signs comprising a display.

The following exemplary and non-limiting embodiments provide various implementations of the disclosure. Example 1 is directed to a Totally Internally Reflective (TIR) display, comprising: a front assembly having a front sheet and a front electrode; a back assembly having a backplane and a rear electrode, the back assembly and the front assembly forming a gap therebetween; a medium to fill the gap, the medium having a first refractive index value; a plurality of electrophoretically mobile light absorbing particles and a plurality of light reflecting particles dispersed in the medium; and wherein the at least one light reflecting particle further comprises a core and a coating substantially covering the core, and wherein the coating having a second refractive index value.

Example 2 is directed to the TIR display of example 1, wherein the first refractive index value is substantially similar to the second refractive index value.

Example 3 is directed to the TIR display of example 1, wherein the first refractive index value and the second refractive index value are within a range of about 0-20% of one another.

Example 4 is directed to the TIR display of example 1, wherein the first refractive index value and the second refractive index values are within a range of about 10% of one another.

Example 5 is directed to the TIR display of example 1, wherein the light reflecting particles comprises about 0.5-30 weight % of the total composition of the medium, light absorbing particles and light reflecting particles within the gap.

Example 6 is directed to the TIR display of example 1, wherein the coating defines a steric hindrance layer.

Example 7 is directed to the TIR display of example 6, wherein the steric hindrance layer of the light reflecting particles prevents the core of the particles to contact at least one of the front or the rear electrodes.

Example 8 is directed to the TIR display of example 1, wherein the front assembly further comprises a dielectric layer and wherein the front assembly further defines at least one convex protrusion extending into the gap.

Example 9 is directed to the TIR display of example 1, further comprising a housing to receive the front assembly, the back assembly and the medium.

Example 10 is directed to the TIR display of example 1, further comprising at least one sidewall.

Example 11 is directed to a Totally Internally Reflective (TIR) display, comprising: a front assembly having a front electrode; a back assembly having a rear electrode, the back assembly and the front assembly forming a gap therebetween; a medium to fill the gap, the medium having a first refractive index value; a plurality of electrophoretically mobile light absorbing particles and a plurality of light reflecting particles dispersed in the medium, the light reflecting particles having a core and a coating, the coating having a second refractive index value; and wherein the coating of at least one light reflecting particle creates a steric hindrance to prevent the core of the at least one light reflecting particle to substantially come into contact with the front electrode or the rear electrode.

Example 12 is directed to the TIR display of example 11, wherein the coating comprises one or more of alumina, silica or a polymer.

Example 13 is directed to the TIR display of example 11, wherein the first refractive index value is substantially similar to the second refractive index value.

Example 14 is directed to the TIR display of example 11, wherein the first refractive index value and the second refractive index value are within a range of about 0-20% of one another.

Example 15 is directed to the TIR display of example 11, wherein the first refractive index value and the second refractive index values are within a range of about 10% of one another.

Example 16 is directed to the TIR display of example 11, wherein the light reflecting particles comprises about 0.5-30 weight % of the total weight of the medium, light absorbing particles and light reflecting particles within the gap.

Example 17 is directed to the TIR display of example 11, wherein the coating on at least one of the plurality of light reflecting particles has a refractive index that is within about 20% of the refractive index of the medium.

Example 18 is directed to the TIR display of example 11, further comprising a biasing source to bias the front electrode relative to the back electrode.

Example 19 is directed to a method for switching a Totally Internally Reflective (TIR) image display from a dark state to a light state, comprising: receiving a plurality of incoming light rays at a front electrode of the display, the front electrode of the display forming a gap with a back electrode of the display; moving a plurality of light absorbing particles to the front electrode by supplying a first bias to the front electrode relative to the back electrode, the light absorbing particles substantially absorbing the incoming light rays at the front electrode; moving a plurality of light reflecting particles proximal to the front electrode by supplying a second bias to the front electrode relative to the back electrode, the light reflective particles substantially reflecting the plurality of incoming light rays back through the front electrode, the light-reflecting particles having a core and a coating; and wherein the coating of the plurality of light refracting particles comprises a steric hindrance layer to remain proximal to the front surface without contacting the front electrode.

Example 20 is directed to the method of example 19, further comprising switching from the second bias to the first bias to move the plurality of light refractive particles away from the front electrode and proximal to the back electrodes and wherein the cores of the plurality of light refractive particles do not come into contact the back electrode.

Example 21 is directed to the method of example 19, further comprising disposing a medium at the gap wherein the medium comprises a refractive index value.

Example 22 is directed to the method of example 21, wherein at least one of the plurality of light refractive particles has a refractive index value that is substantially the same as the refractive index value of the medium.

Example 23 is directed to the method of example 21, wherein at least one of the plurality of light refractive particles has a refractive index value that is larger than the refractive index value of the medium.

Example 24 is directed to the method of example 21, wherein at least one of the plurality of light refractive particles has a refractive index value that is within about 20% or less than the refractive index value of the medium.

Example 25 is directed to the method of example 21, wherein at least one of the plurality of light refractive particles has a refractive index value that is within about 10% or less than the refractive index value of the medium.

Example 26 is directed to the method of example 19, wherein the region proximal to the front electrode defines an evanescent region.

While the principles of the disclosure have been illustrated in relation to the exemplary embodiments shown herein, the principles of the disclosure are not limited thereto and include any modification, variation or permutation thereof.

What is claimed is:

1. A Totally Internally Reflective (TIR) display, comprising:
a front assembly having a front sheet and a front electrode;
a back assembly having a backplane and a rear electrode, the back assembly and the front assembly forming a gap therebetween;
a medium to fill the gap, the medium having a first refractive index value;
a plurality of electrophoretically mobile light absorbing particles and a plurality of light reflecting particles dispersed in the medium; and
wherein the at least one light reflecting particle further comprises a core and a coating substantially covering the core, and wherein the coating having a second refractive index value.

2. The TIR display of claim 1, wherein the first refractive index value is substantially similar to the second refractive index value.

3. The TIR display of claim 1, wherein the first refractive index value and the second refractive index value are within a range of about 0-20% of one another.

4. The TIR display of claim 1, wherein the first refractive index value and the second refractive index values are within a range of about 10% of one another.

5. The TIR display of claim 1, wherein the light reflecting particles comprises about 0.5-30 weight % of the total composition of the medium, light absorbing particles and light reflecting particles within the gap.

6. The TIR display of claim 1, wherein the coating defines a steric hindrance layer.

7. The TIR display of claim 6, wherein the steric hindrance layer of the light reflecting particles prevents the core of the particles to contact at least one of the front or the rear electrodes.

8. The TIR display of claim 1, wherein the front assembly further comprises a dielectric layer and wherein the front assembly further defines at least one convex protrusion extending into the gap.

9. The TIR display of claim 1, further comprising a housing to receive the front assembly, the back assembly and the medium.

10. The TIR display of claim 1, further comprising at least one sidewall.

11. A Totally Internally Reflective (TIR) display, comprising:
a front assembly having a front electrode;
a back assembly having a rear electrode, the back assembly and the front assembly forming a gap therebetween;
a medium to fill the gap, the medium having a first refractive index value;
a plurality of electrophoretically mobile light absorbing particles and a plurality of light reflecting particles dispersed in the medium, the light reflecting particles having a core and a coating, the coating having a second refractive index value; and
wherein the coating of at least one light reflecting particle creates a steric hindrance to prevent the core of the at least one light reflecting particle to substantially come into contact with the front electrode or the rear electrode.

12. The TIR display of claim 11, wherein the coating comprises one or more of alumina, silica or a polymer.

13. The TIR display of claim 11, wherein the first refractive index value is substantially similar to the second refractive index value.

14. The TIR display of claim 11, wherein the first refractive index value and the second refractive index value are within a range of about 0-20% of one another.

15. The TIR display of claim 11, wherein the first refractive index value and the second refractive index values are within a range of about 10% of one another.

16. The TIR display of claim 11, wherein the light reflecting particles comprises about 0.5-30 weight % of the total weight of the medium, light absorbing particles and light reflecting particles within the gap.

17. The TIR display of claim 11, wherein the coating on at least one of the plurality of light reflecting particles has a refractive index that is within about 20% of the refractive index of the medium.

18. The TIR display of claim 11, further comprising a biasing source to bias the front electrode relative to the back electrode.

19. A method for switching a Totally Internally Reflective (TIR) image display from a dark state to a light state, comprising:
receiving a plurality of incoming light rays at a front electrode of the display, the front electrode of the display forming a gap with a back electrode of the display;
moving a plurality of light absorbing particles to the front electrode by supplying a first bias to the front electrode relative to the back electrode, the light absorbing particles substantially absorbing the incoming light rays at the front electrode;
moving a plurality of light reflecting particles proximal to the front electrode by supplying a second bias to the front electrode relative to the back electrode, the light reflective particles substantially reflecting the plurality of incoming light rays back through the front electrode, the light-reflecting particles having a core and a coating; and
wherein the coating of the plurality of light refracting particles comprises a steric hindrance layer to remain proximal to the front surface without contacting the front electrode.

20. The method of claim 19, further comprising switching from the second bias to the first bias to move the plurality of light refractive particles away from the front electrode and proximal to the back electrodes and wherein the cores of the plurality of light refractive particles do not come into contact the back electrode.

21. The method of claim 19, further comprising disposing a medium at the gap wherein the medium comprises a refractive index value.

22. The method of claim 21, wherein at least one of the plurality of light refractive particles has a refractive index value that is substantially the same as the refractive index value of the medium.

23. The method of claim 21, wherein at least one of the plurality of light refractive particles has a refractive index value that is larger than the refractive index value of the medium.

24. The method of claim 21, wherein at least one of the plurality of light refractive particles has a refractive index value that is within about 20% or less than the refractive index value of the medium.

25. The method of claim 21, wherein at least one of the plurality of light refractive particles has a refractive index value that is within about 10% or less than the refractive index value of the medium.

26. The method of claim 19, wherein the region proximal to the front electrode defines an evanescent region.
